(19) United States
(12) Patent Application Publication
(10) Pub. No.: US 2018/0007888 A1
(43) Pub. Date: Jan. 11, 2018

(54) Insect Trap Device

(71) Applicant: Mike Clabaugh, Stanhope, IA (US)

(72) Inventor: Mike Clabaugh, Stanhope, IA (US)

(21) Appl. No.: 15/204,235

(22) Filed: Jul. 7, 2016

(51) Int. Cl. A01M 1/14; A01M 1/24; A01M 1/12; F16M 13/02; A01M 1/10

(52) U.S. Cl. CPC A01M 1/14; F16M 13/02; A01M 1/103; A01M 1/12; A01M 1/24

(57) ABSTRACT

An insect trap device efficiently catches and traps insects. The device includes a connector coupled to a housing such that the housing is configured for being coupled to a surface. A rod is coupled to and extends from the housing to be parallel to the surface. A motor is positioned in the housing and coupled to the rod to move the rod between a raised position and a lowered position. A motion sensor is positioned on the housing adjacent to the rod wherein the motion sensor is configured for detecting an insect within a range of movement of the rod. The motion sensor triggers the motor to move the rod when the motion sensor detects the insect. An adhesive is exposed on a surface of the rod wherein the adhesive is configured for adhering the insect to the rod when the rod contacts the insect.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to insect trap devices and more particularly pertains to a new insect trap device for efficiently catching and trapping insects.

### BRIEF SUMMARY OF THE INVENTION

An embodiment of the disclosure meets the needs presented above by generally comprising a connector coupled to a housing such that the housing is configured for being coupled to a surface. A rod is coupled to and extends from the housing to be parallel to the surface. A motor is positioned in the housing and coupled to the rod to move the rod between a raised position and a lowered position. A motion sensor is positioned on the housing adjacent to the rod wherein the motion sensor is configured for detecting an insect within a range of movement of the rod. The motion sensor triggers the motor to move the rod when the motion sensor detects the insect. An adhesive is exposed on a surface of the rod wherein the adhesive is configured for adhering the insect to the rod when the rod contacts the insect.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of an insect trap device according to an embodiment of the disclosure.

FIG. 2 is a detailed partial top front side perspective view of an embodiment of the disclosure.

FIG. 3 is a detailed partial top back side perspective view of an embodiment of the disclosure.

FIG. 4 is a cross-sectional view of an embodiment of the disclosure taken along line 4-4 of FIG. 1.

FIG. 5 is a front view of an embodiment of the disclosure in use.

### DETAILED DESCRIPTION OF THE INVENTION

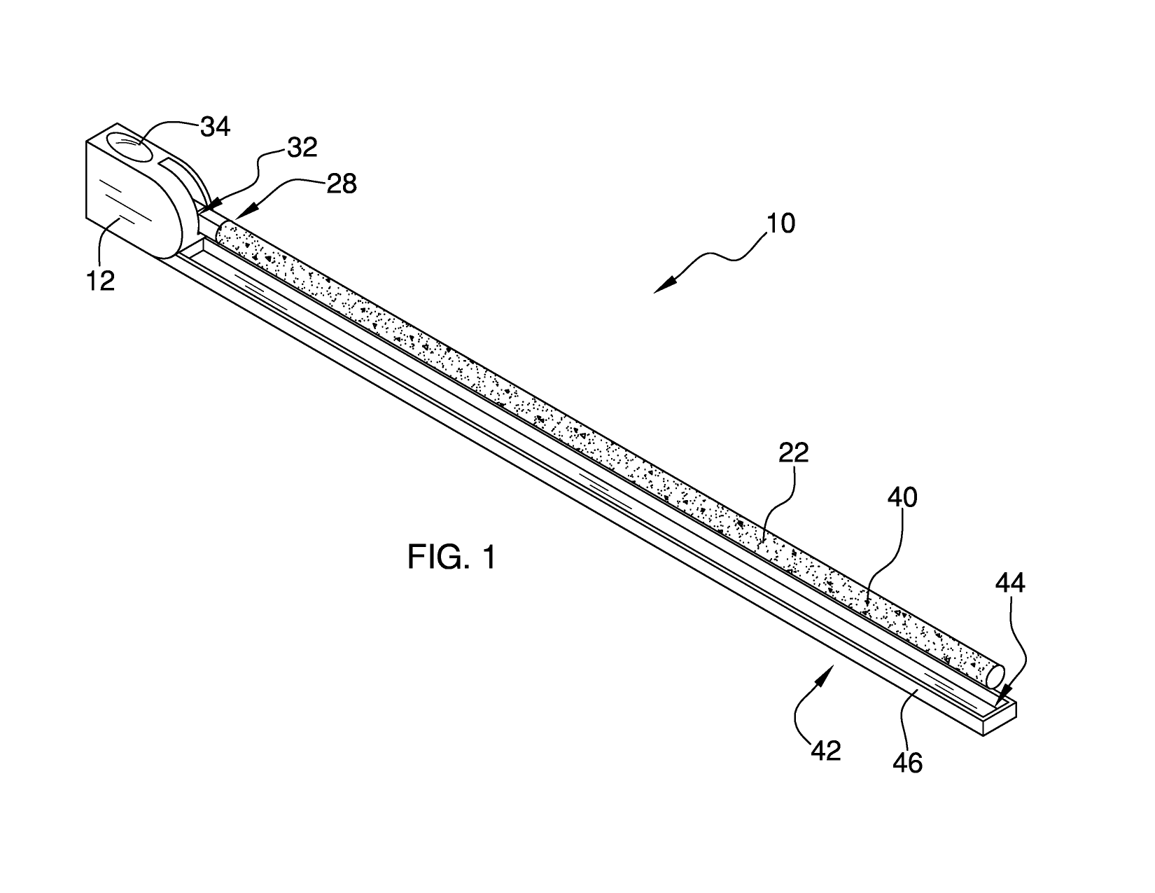

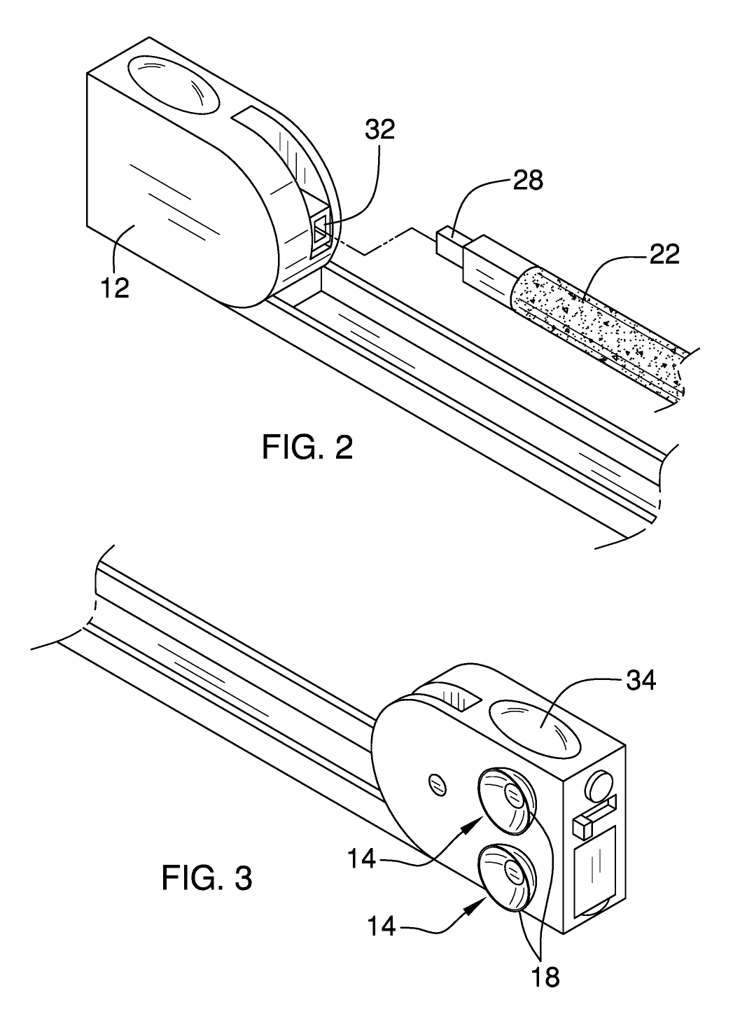

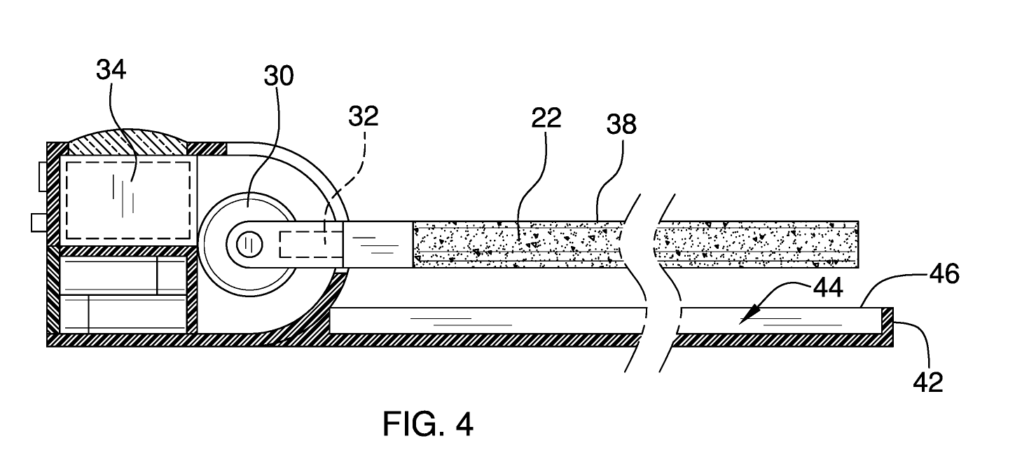

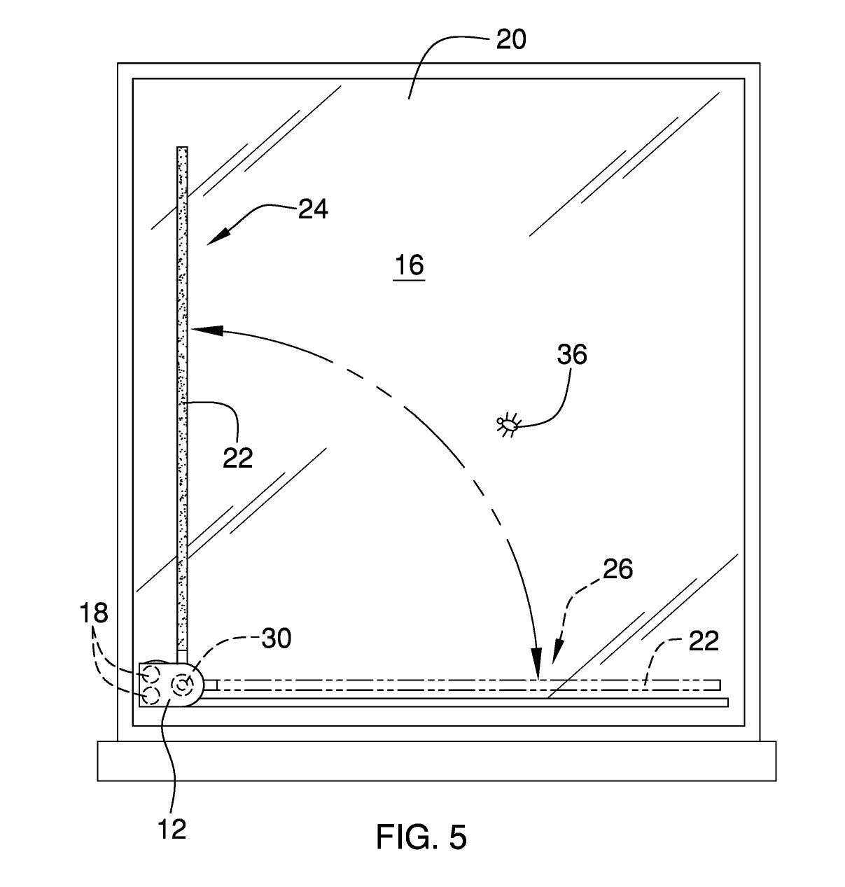

With reference now to the drawings, and in particular to FIGS. 1 through 5 thereof, a new insect trap device embodying the principles and concepts of an embodiment of the disclosure and generally designated by the reference numeral 10 will be described.

As best illustrated in FIGS. 1 through 5, the insect trap device 10 generally comprises a housing 12 and a connector 14 coupled to the housing 12 such that the housing 12 is configured for being coupled to a surface 16. The connector 14 is a plurality of suction cups 18 wherein the connector 14 is configured to be coupled to a window 20. A rod 22 is coupled to and extends from the housing 12 such that the rod 22 is configured to be parallel to the surface 16. The rod 22 is pivotable between a raised position 24 and a lowered position 26. The position of the rod 22 in the raised position 24 is perpendicular to the position of the rod 22 in the lowered position 26.

A motor 30 is coupled to the housing 12. The motor 30 is positioned in the housing 12. The motor 30 is coupled to the rod 22 wherein the motor 30 moves the rod 22 between the raised position 24 and the lowered position 26. A socket 32 is coupled to the motor 30. A proximal end 28 of the rod 22 relative to the housing 12 is insertable into the socket 32 wherein the rod 22 is removably coupled to the motor 30. A motion sensor 34 is coupled to the housing 12. The motion sensor 34 is positioned on the housing 12 adjacent to the rod 22 wherein the motion sensor 34 is configured for detecting an insect 36 within a range of movement of the rod 22. The motion sensor 34 is operationally coupled to the motor 30 wherein the motor 30 is configured to move the rod 22 when the motion sensor 34 detects the insect 36. The rod 22 is moved by the motor 30 at a speed to encourage contact between the rod 22 and the insect 36. An adhesive 38 is exposed on a surface 40 of the rod 22 wherein the adhesive 38 is configured for adhering the insect 36 to the rod 22 when the rod 22 contacts the insect 36.

Additionally, a tray 42 is coupled to and extends from the housing 12. The tray 42 is positioned in spaced parallel relationship to the rod 22 when the rod 22 is in the lowered position 26. The tray 42 has a trough 44 defined by a raised peripheral lip 46. The rod 22 is coplanar with the trough 44. The trough 44 catches and holds the insect 36 in the event the adhesive 38 is not used, becomes ineffective, or in the event the insect 36 is not otherwise adhered to the rod 22. The adhesive 38 may be provided using a removable tape or sheath allowing for replacement of the adhesive 38 as needed.

In use, the housing 12 is attached to the surface 16 using the suction cups 18. The rod 22 is set in the raised position 24. Upon detection of the insect 36 within the range of motion of the rod 22, the motor 30 is activated to move the rod 22. Contact by the rod 22 will serve to at least stun the insect 36 and adhere the insect 36 to the surface 40 or deliver the insect 36 to the trough 44 for later disposal.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An insect trap device comprising:
a housing;
a connector coupled to said housing such that said housing is configured for being coupled to a surface;
a rod coupled to and extending from said housing such that said rod is configured to be parallel to the surface, said rod being pivotable between a raised position and a lowered position;
a motor coupled to said housing, said motor being positioned in said housing, said motor being coupled to said rod wherein said motor moves said rod between said raised position and said lowered position;
a motion sensor coupled to said housing, said motion sensor being positioned on said housing adjacent to said rod wherein said motion sensor is configured for detecting an insect within a range of movement of said rod, said motion sensor being operationally coupled to said motor wherein said motor is configured to move said rod when said motion sensor detects the insect;
an adhesive being exposed on a surface of said rod wherein said adhesive is configured for adhering the insect to the rod when the rod contacts the insect.

2. The device of claim 1, further comprising a tray coupled to and extending from said housing, said tray being positioned in spaced parallel relationship to said rod when said rod is in the lowered position.

3. The device of claim 1, further comprising said connector being a plurality of suction cups wherein said connector is configured to be coupled to a window.

4. The device of claim 1, further comprising a socket coupled to said motor, a proximal end of said rod relative to said housing being insertable into said socket wherein said rod is removably coupled to said motor.

5. The device of claim 1, further comprising said raised position being perpendicular to said lowered position

6. The device of claim 1, further comprising said tray having a trough defined by a raised lip peripheral lip, said rod being coplanar with said trough.

7. An insect trap device comprising:
a housing;
a connector coupled to said housing such that said housing is configured for being coupled to a surface, said connector being a plurality of suction cups wherein said connector is configured to be coupled to a window;
a rod coupled to and extending from said housing such that said rod is configured to be parallel to the surface, said rod being pivotable between a raised position and a lowered position, said raised position being perpendicular to said lowered position;
a motor coupled to said housing, said motor being positioned in said housing, said motor being coupled to said rod wherein said motor moves said rod between said raised position and said lowered position;
a socket coupled to said motor, a proximal end of said rod relative to said housing being insertable into said socket wherein said rod is removably coupled to said motor;
a motion sensor coupled to said housing, said motion sensor being positioned on said housing adjacent to said rod wherein said motion sensor is configured for detecting an insect within a range of movement of said rod, said motion sensor being operationally coupled to said motor wherein said motor is configured to move said rod when said motion sensor detects the insect;
an adhesive being exposed on a surface of said rod wherein said adhesive is configured for adhering the insect to the rod when the rod contacts the insect; and
a tray coupled to and extending from said housing, said tray being positioned in spaced parallel relationship to said rod when said rod is in the lowered position, said tray having a trough defined by a raised lip peripheral lip, said rod being coplanar with said trough.
